(19) United States
(12) Patent Application Publication
(10) Pub. No.: US 2002/0099513 A1
(43) Pub. Date: Jul. 25, 2002

(54) Systems and methods for testing multi-gigahertz digital systems and components

(76) Inventor: David Clark Keezer, Roswell, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/057,590

(22) Filed: Jan. 24, 2002

Related U.S. Application Data
(60) Provisional application No. 60/264,212, filed on Jan. 25, 2001.

(51) Int. Cl. G06F 19/00; G01M 19/00

(52) U.S. Cl. 702/125

(57) ABSTRACT

Systems and methods for testing digital components in the multiple gigahertz range using an automatic test system. A digital component-under-test is connected to the automatic test system having a driver module and a receiver module coupled to the automatic test system. The driver module generates high-speed signals that are provided to the digital component-under-test. The receiver module samples the high speed output data from the digital component-under-test and transmits sampled data to the automatic test equipment at a data rate supported by the automatic test equipment.

### CROSS-REFERENCE TO RELATED APPLICATION

This application claims priority to copending U.S. provisional application entitled, “System and Technique for Testing Multigigahertz Digital Systems and Components,” having ser. No. 60/264,212, filed Jan. 25, 2001, which is entirely incorporated herein by reference.

### TECHNICAL FIELD

The present invention is generally related to component testing and, more particularly, is related to systems and methods for testing multigigahertz digital systems and components.

### BACKGROUND OF THE INVENTION

One method for testing digital integrated circuits and systems is by using automatic test equipment (ATE). ATE systems cost about $10,000 per channel. Complex integrated circuits require hundreds of channels to be tested. Projected costs for ATE systems are expected to exceed $20-30 million over the next five years.

ATE systems test a number of parameters. Typical devices tested using ATE systems include, for instance, high speed digital devices, power amplifiers, attenuators, and radio frequency signals. Current and planned digital logic devices require testing at high frequencies in the multi-gigahertz range. For instance, testing requirements can exceed 3 gigahertz (Ghz), and are expected to increase to greater than 10 Ghz within the next few years.

Continued use of the existing ATE capital base is highly desired. Yet, existing ATE systems do not support the high frequencies that are to require testing. Current ATE systems are capable of operating at a frequency range of about 1.5 Ghz and more typically operate in a range of 400 to 500 Mhz. Certain digital devices require testing at frequencies beyond those supported by currently available ATE systems.

Few choices exist for testing digital devices beyond 1.5 Ghz. Testing at a lower frequency may be viable approach for certain devices if a correlation between lower-frequency and higher-frequency behavior can be determined in advance. However, there are a lot of uncertainties associated with this approach. As a result, direct demonstration of a device's performance through high speed testing remains a common requirement.

Further, existing ATE systems have a timing accuracy in the range of ±50 pico-seconds (ps), which is suitable for testing at 1 Ghz, but barely adequate for testing at 3 Ghz. Moreover, even if an ATE were available to support these frequency ranges with desired timing accuracy, replacing the existing base of ATE systems with higher-performance ATE systems is cost prohibitive.

Based on the foregoing, it should be appreciated that there is a need for improved systems and methods that address these and/or other shortcomings of the prior art.

### SUMMARY OF THE INVENTION

The present invention provides systems and methods for testing digital components in the multiple gigahertz range. Briefly described, in architecture, one embodiment of the system, among others, can be implemented as follows. A system for testing a multiple gigahertz device using automatic test equipment, comprises a driver circuit coupled to the automatic test equipment and the multiple gigahertz device-under-test, the driver circuit for combining signals provided by the automatic test equipment and generating an output signal having a speed greater than the speeds of the signals provided to the multiple gigahertz device-under-test. A receiver circuit coupled to the automatic test equipment containing the multiple gigahertz device-under-test, which samples the high speed output data from the multiple gigahertz device-under-test and transmits that data to the automatic test equipment at a data rate supported by the automatic test equipment. A clock signal coupled to the receiver circuit defines the sampling time of the receiver circuit.

The present invention can also be viewed as providing methods for testing multiple-gigahertz digital components. In this regard, one embodiment of such a method, among others, can be broadly summarized by the following steps: connecting a unit under test to test equipment, generating a plurality of high speed signals to the unit under test using a driver module, and receiving the high speed signals from the unit under test by a receiver module that samples the high speed signals and sends the sampled signals to the test equipment.

In another embodiment, the invention is a method for calibrating a test system to maintain timing accuracy in the test system. The test system includes an automatic test equipment, a driver module, and a receiver module and tests units requiring mega-gigahertz test signals. The method comprises identifying sources of delays throughout the system, measuring the delays from the identified sources of delay and adjusting settings on the automatic test equipment to correct for the delays and to achieve an overall system delay of approximately ±25 ps.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram of a system for testing digital circuits operating at multi-gigahertz speeds according to one aspect of the invention.

FIG. 2 is a flow chart of a method for using the testing system of FIG. 1.

FIGS. 3A and 3B are cross section views of one embodiment of a test configuration for testing the system of FIG. 1.

FIG. 4 is a schematic view of an embodiment of a test configuration of the system of FIG. 1 and/or FIGS. 3A and 3B.

FIG. 5A is schematic diagram of an embodiment of a driver module of the system of FIG. 1, FIGS. 3A and 3B, and/or FIG. 5.

FIG. 5B is a schematic diagram of an embodiment of timing the signals of the driver module of FIG. 5A.

FIG. 6 is a schematic diagram of an embodiment of a receiver module of the system of FIG. 1, FIGS. 3A and 3B, and/or FIG. 5.

FIG. 7 is a flow chart of the process for implementing the system of FIG. 1.

FIG. 8 is a flow chart of the process for calibrating the system of FIG. 1, FIGS. 3A and 3B, and/or FIG. 5.

### DETAILED DESCRIPTION OF THE PREFERRED EMBODIMENT

Disclosed herein are systems and methods for testing digital circuits operating at multi-gigahertz speeds. To facilitate description of the inventive system, an example device that can be used to implement the systems and methods for testing digital circuits operating at multi-gigahertz speeds is discussed with reference to the figures. Although this system is described in detail, it will be appreciated that this system is provided for purposes of illustration only and that various modifications are feasible without departing from the inventive concept. After the example system has been described, an example of operation of the device will be provided to explain the manner in which the device can be used to test digital circuits operating at multigigahertz speeds.

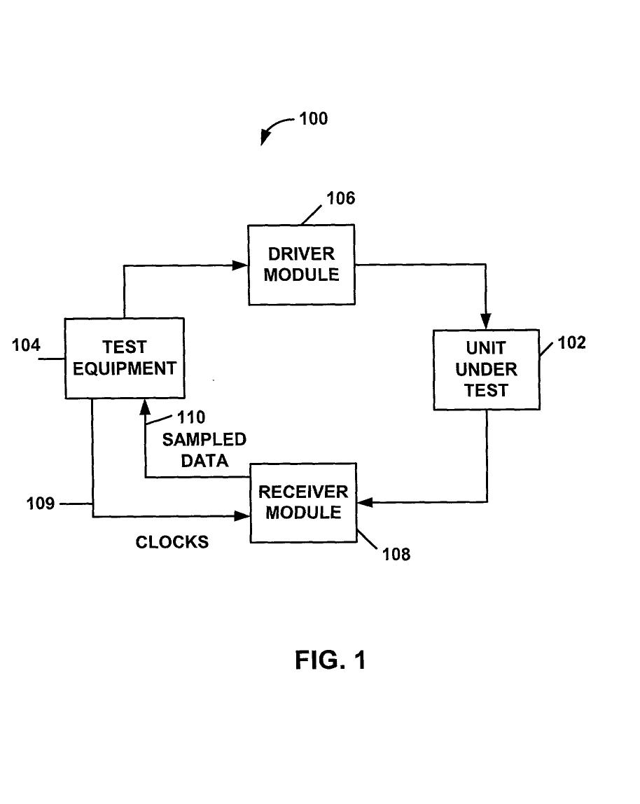

Referring now in more detail to the drawings, in which like numerals indicate corresponding parts throughout the several views, FIG. 1 is a block diagram depicting an embodiment of a system 100 that can be used to implement a system for testing digital circuits operating at multi-gigahertz speeds in accordance with the present invention. Generally, the system 100 includes a unit under test (UUT) 102, test equipment 104, a driver module 106 and a receiver module 108. The test equipment 104 includes automatic test equipment (ATE) designed to test various types and parameter of UUTs 102 such as digital integrated circuits at certain frequencies. UUTs 102 of the present invention can operate at data rates in the gigahertz range including 3 Ghz to 6 Ghz, among others. The driver module 106 provides high speed input signals to the UUT 102. The receiver module 108 samples the high speed UUT 102 output data and transmits the output data at lower rates to the ATE 104. Multiple driver modules 106 and receiver modules 106 are possible. A clock signal 109 from the test equipment 104 defines the sampling time. Sampled data 110 from the receiver module 108 is transmitted back to the ATE 104.

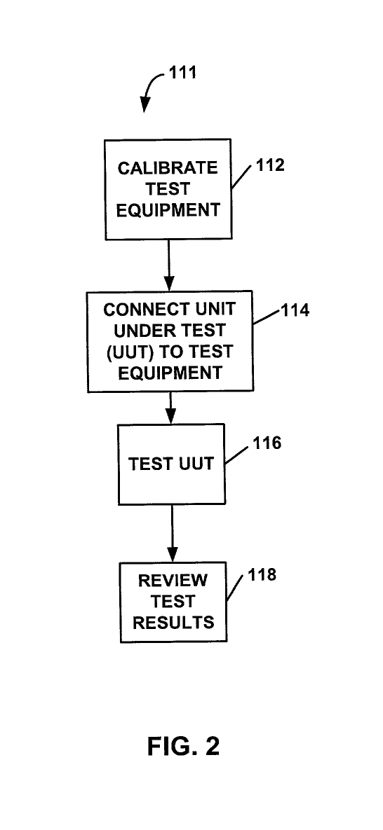

FIG. 2 depicts a flow chart 111 of a method for using the system 100 of FIG. 1. At 112, the ATE 104 is calibrated. As in many test systems, delays are inherent in the system 100. Calibration of the ATE 104 to account for the delays provides a system 100 having timing accuracies in the range of about ±20 ps to about 30 ps. At 114, the UUT 102 is connected to the ATE 104. At 116, the UUT 102 is tested. At 118, the test results achieved are reviewed and compared to expected results.

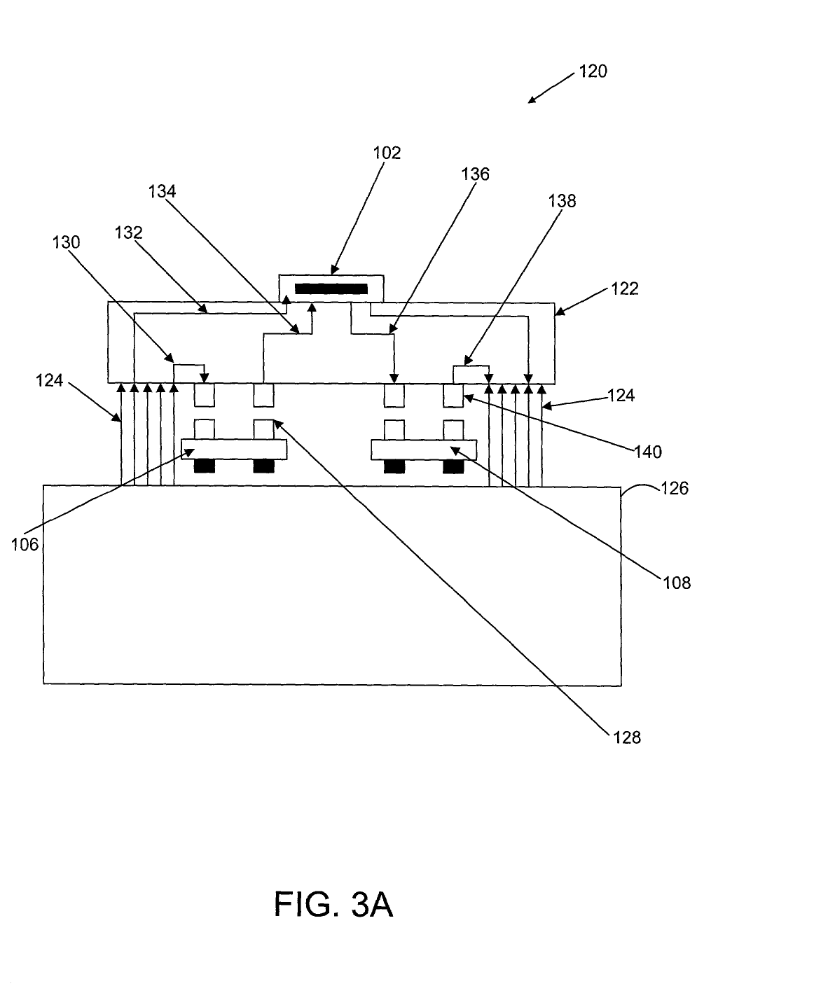

FIGS. 3A and 3B are cross section views of a test configuration 120 for testing the UUT 102 of FIG. 1. Referring to FIG. 3A, a cross section view of a multiple-gigahertz digital test system configuration 120 with driver module 106 and receiver module 108 detached from an interface printed circuit board (PCB) 122. The driver module 106 and the receiver module 108 are mounted to the interface printed circuit board (PCB) 122 that provides controlled-impedance connections between the modules 106, 108 and the ATE 104; and between the modules 106, 108 and the UUT 102. Some, non-critical signals are connected directly between the UUT 102 and ATE 104 as is standard practice.

The UUT 102 is mounted within a suitable test socket (not shown) that provides electrical connections between the UUT 102 and interface PCB 122. The test socket can be mounted on a top side of the PCB 122. The driver module 106 and the receiver module 108 can be mounted on a bottom side of the PCB 122. The PCB 122 connects to the ATE 104 using “pogo pin” type contacts 124 that are traditionally used in existing ATE systems 104.

In one embodiment, the PCB 122 has four 12″ sides and a thickness of about 0.156,″ which provides suitable mechanical rigidity. A test socket can be provided in the center of the PCB 122. The PCB 122 can be organized in quadrants with each quadrant containing contact points for blocks of 64 signal pogo pins 124 (and their respective one hundred twenty eight ground contacts). A metal support frame (not shown) surrounding the PCB 122 can be used to mount the PCB 122 to the ATE test head 126.

There is a limited accessible board area on the bottom side of the PCB 122 which causes the physical design of the PCB 122 to be a challenge. A limitation is the development of a mounting fixture that mechanically attaches to the ATE test head 126. The interface PCB 122 and the modules 106, 108 have a design that allows them to fit within a small opening in the ATE test head 126.

In one embodiment, the interface PCB 122 comprises 14 layers of patterned metal. The layers include four layers of 50-ohm controlled impedance stripline interconnects which carry all the high speed signals, six layers of ground planes, including top and bottom layers, which help define the 50-ohm impedance of the signal lines, and four split-plane layers to support power supplies. Standard FR-4 epoxy-glass is used for an inter-metal insulation material because all signal lengths are limited to a few inches or less and thus, signal attenuation is not a major concern even at high frequencies. Electroplated gold over nickel plating is used on exposed metal surfaces to provide a reliable connection to the ATE pogo pins 124 and test socket (not shown).

High frequency (HF) connectors 128 connect the modules 106, 108 to the ATE test head 126. Mounting sockets 140 on the interface PCB 122 provide for connecting the modules 106, 108 to the interface PCB 122. Signal inputs 130 from the ATE test head 126 are coupled to the driver module 106 (when connected). Certain low speed signals, not critical to the present invention, are connected directly between the UUT 102 and ATE 104 on connection 132. The driver module(s) 106 generates high speed outputs that serve as high speed signals are carried on connection 134 to the UUT 102. High speed outputs 136 from the UUT 102 are coupled into the receiver module 108. Sampled lower frequency outputs from the receiver module 108 are sent to the ATE test head 126.

Referring to FIG. 3B, a cross section view of a configuration 142 for providing the test system 100 is shown with driver module 106 and receiver module 108 connected to the interface PCB 122. The modules 106, 108 have been attached to the interface PCB 122 using the connectors mounting sockets 128.

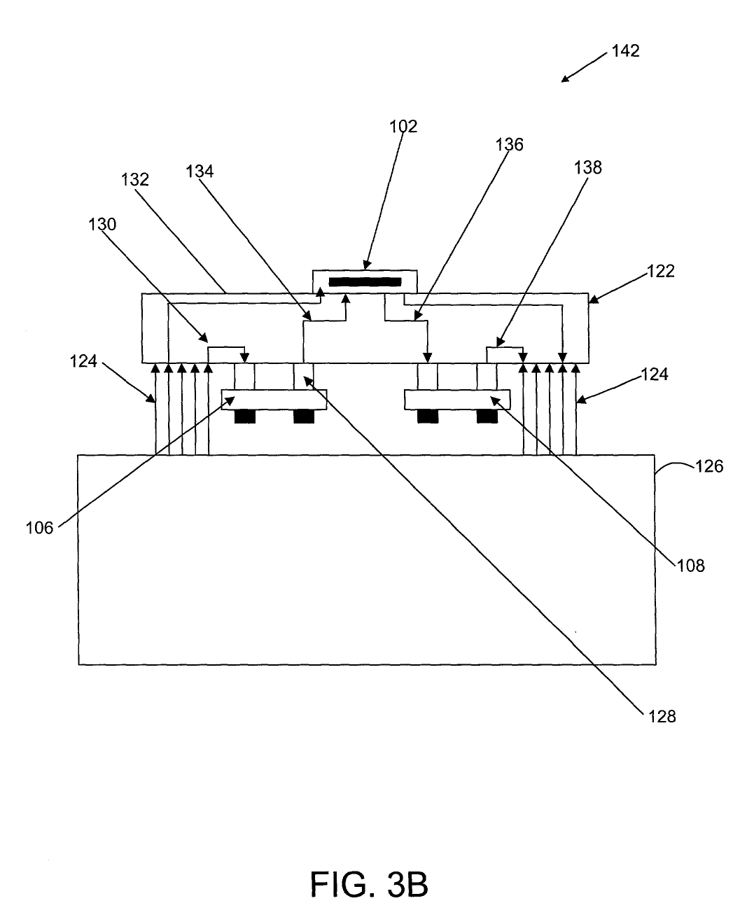

FIG. 4 is a block diagram of an illustrative example of a test configuration 144 for testing the UUT 102 of FIG. 1 and FIGS. 3A and 3B. In one embodiment, the UUT 102 requires several high-speed differential-pair inputs 146, 148, from the driver modules 106a-b and provides several high-speed differential-pair outputs 150, 152, to the receiver modules 108a-b. Various low-speed control signals 154, 156 from the ATE pogo pins 124a-d are coupled to the UUT 102.

FIG. 4 shows only two driver modules 106a-b, however the present invention is not limited to only two driver modules 106. In an embodiment indicated in FIG. 4, each of the driver modules 106a-b provides high speed data outputs to the UUT 102. In one embodiment, 18 high speed data outputs are provided to the UUT 102.

In addition, FIG. 4 shows only two receiver modules 108a-b. However, the present invention is not limited to only two receiver modules 108a-b. In the embodiment shown in FIG. 4, the receiver module 108a-b is timed using a clock 158a-b from the ATE 104 sent via the ATE pogo pins 124a-d. In an alternative embodiment, the receiver modules 108a-b receive clock signals from a source independent of the ATE 104. The receiver modules 108a-b can receive clock pulses 158a-b and send sampled data bits 160a-b to the ATE 104. In one embodiment, 34 clock pulses are sent to the receiver module 108a-b and 34 sampled data bits are sent to the ATE 104.

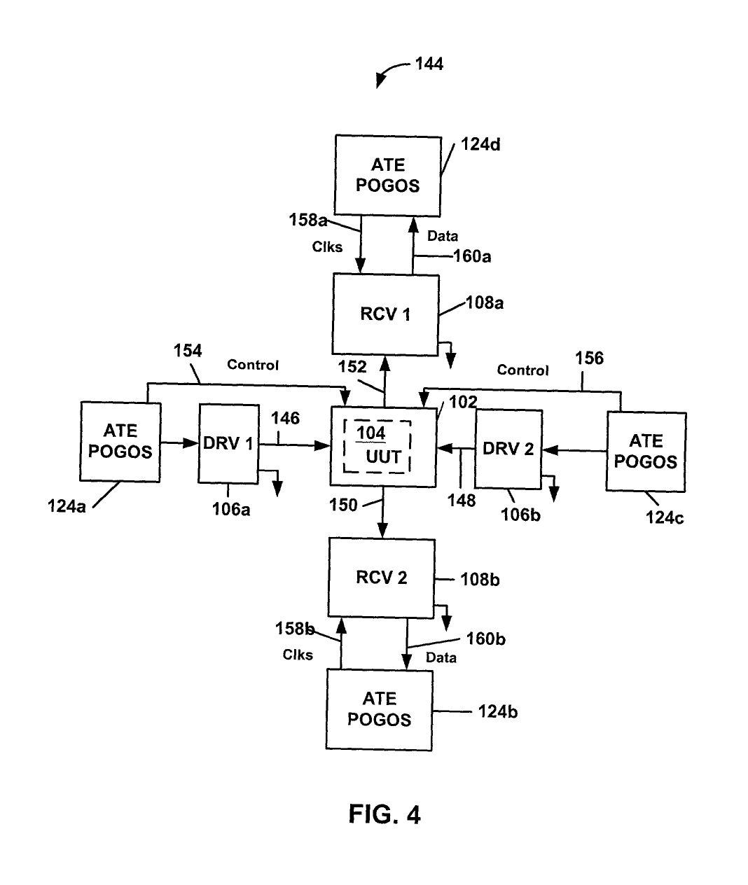

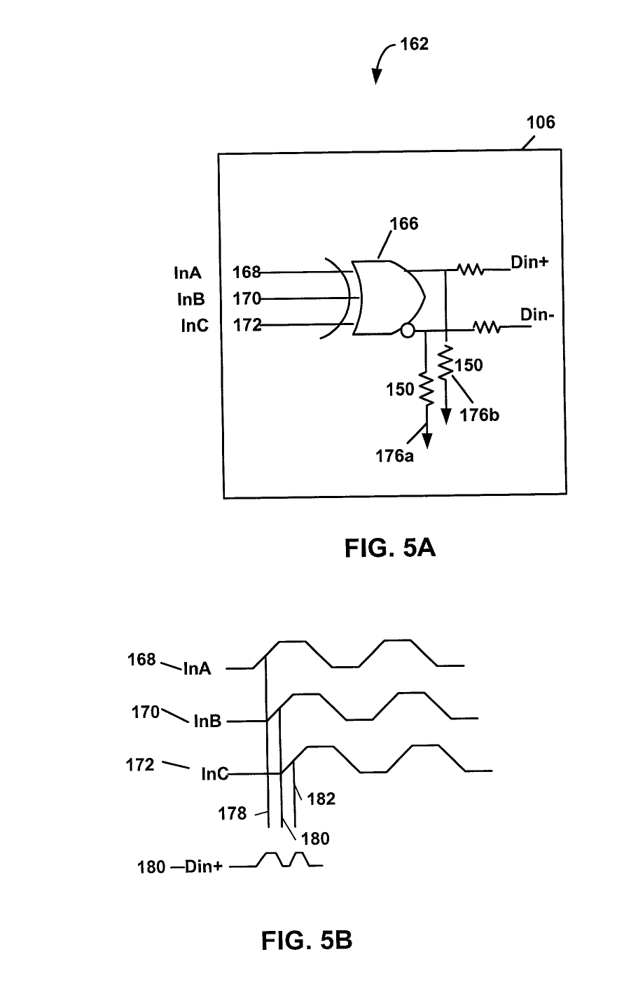

FIG. 5A is a schematic diagram 162 of an embodiment of the driver module 106 of FIG. 1, FIGS. 3A and 3B, and FIG. 4. Generally, the driver module 106 comprises digital logic that receives lower speed signals from the ATE 104, for instance 1.5 Ghz signals, and, by combining the lower speed signals, provides higher speed signals, for instance, 3 Ghz, to the UUT 102. Each signal may be referred to as a channel. At 3 Ghz, logic transitions in the driver module 106 occur in about 300 ps or less, and preferably at about 100 ps.

In one embodiment, the driver module 106 is a high-speed exclusive-OR (XOR) logic gate 166 that combines several groups of signals provided by the ATE 104. For illustrative purposes, the driver module 106 shown in FIG. 5A uses three signals InA, InB, and InC, on lines 168, 170, and 172, respectively, from the ATE 104. In an alternative embodiment, two 2-input XOR gates can be used to provide the logic in the driver module 106.

A suitable XOR gate 166 is provided by ON Semiconductor, model number 10EP08. The XOR gate 166 and other semiconductor components are mounted on the multilayer interface PCB 122 with 50-Ohm transmission lines, suitable termination resistors, such as 150 ohm resistors 176a and b, decoupling capacitors (not shown) and high performance connectors.

The XOR gate 166 uses timing from the ATE 104 to phase delay the logic signals 168, 170 and 172, arriving at the XOR gate 166 inputs. The input signals 168, 170 and 172 are staggered in time such that only one input changes at a time. The time between transitions is evenly spaced at the desired high-speed bit rate. For example, if a 3 Giga bit per second (Gbps) signal is desired, then three 1 Gbps ATE signals 168, 170, 172 are offset by ⅓ nano-second (ns) intervals.

For example, as shown in FIG. 5B, signal InA 168 is transitioned at time 178 by the clock pulse Dᵢₙ₊ 180. Signal InB 170 is transitioned at time 182 by clock pulse Dᵢₙ₊ 180. Signal InC 172 is transitioned at time 182 by clock pulse Dᵢₙ₊ 180. The three ATE signal patterns are encoded (algorithm shown below) with the appropriate serial patterns such that when decoded by the XOR gate 166 in real time, they are in effect multiplexed together to form the desired 3 Gbps data pattern. Thus, by transitioning each signal 168, 170, and 172 every 1 ns (i.e. at 1 Gbps), and by phase-delaying each signal by 333 ps, then the output of the XOR gate 166 will transition every 333 ps (i.e. at 3 Gbps).

To produce a specific sequence, the bit patterns for the three XOR inputs should be encoded. An illustrative algorithm for determining the encoded bit patterns follows.

Assumptions:

(1) Let the three inputs to the exclusive-OR gates be denoted as A, B, C.

(2) Let the XOR gate output be denoted as F.

(3) Let the desired output sequence of NRZ data be denoted as F₀, F₁, F₂, . . . F_{N}.

(4) Let the i^{th} bit in F be denoted as Fi. Note: 0 less than or equal to i less than or equal to N.

(5) The timing for DNRZ data transitions on A, B, C is arranged so that A produces an output transition at t=0, B causes output transitions at t=T/3, and C causes output transitions at 2T/3 (where T is the tester period and 3× the desired period of F). This assumes that the time delays through interconnections and the gates themselves have been accounted for through a calibration process.

(6) Let j be the integer value of (i/3). Therefore 0 less than or equal to j less than or equal to N/3.

(7) Let Aⱼ, Bⱼ, Cⱼ denote the j^{th} bit of the input sequence for A, B, C respectively. Note: 0 less than or equal to j less than or equal to N/3.

The algorithm is shown below.

Given the sequence F, wherein F₁ is the i^{th} bit of that sequence, the sequences for the three inputs are as follows:

The following three formulae is used to calculate groups of three inputs by substituting for j, beginning with j=0, then incrementing j by one each time:

Aⱼ=F₃ⱼ⊕Bⱼ₋₁⊕Cⱼ₋₁ Eq. 1

Bⱼ=F₃ⱼ₊₁⊕Aⱼ⊕Cⱼ₋₁ Eq. 2

Cⱼ=F₃ⱼ₊₂⊕Aⱼ⊕Bⱼ Eq. 3

Setting j=0 in these equations produces:

A₀=F₀⊕B₋₁⊕C₋₁ Eq. 4

B₀−F₁⊕A₀⊕C₋₁ Eq. 5

C₀=F₂⊕A₀⊕B₀ Eq. 6

Equations 4-6 determine the first bit for input to each of A, B, C in order to produce the first three bits in F (bits F₀, F₁, F₂). A “set-up” vector is applied to A, B, C prior to the actual start of the desired test. This is indicated by the terms B₋₁ and C₋₁ in Eq. 4 and Eq. 5. Typically, a “dummy” vector is added and the values chosen for A₋₁B₋₁C₋₁ are typically set or 000. The evaluation of Eq. 5 uses the results of Eq. 4. Likewise, Eq. 6 uses the results of Eq. 5.

In addition, these results are used for the next iteration where j=1. Setting j=1 in Eqs. 1-3, produces:

A₁=F₃⊕B₀⊕C₀ Eq. 7

B₁=F₄⊕A₁⊕C₀ Eq. 8

C₁=F₅⊕A₁⊕B₁ Eq. 9

Which gives the second bits for A, B and C. The process continues until all the desired bits in F are used, usually until j=N/3 assuming that N is divisible by 3. By repeatedly applying equations 1-3, the input sequences for A, B, and C can be completely defined.

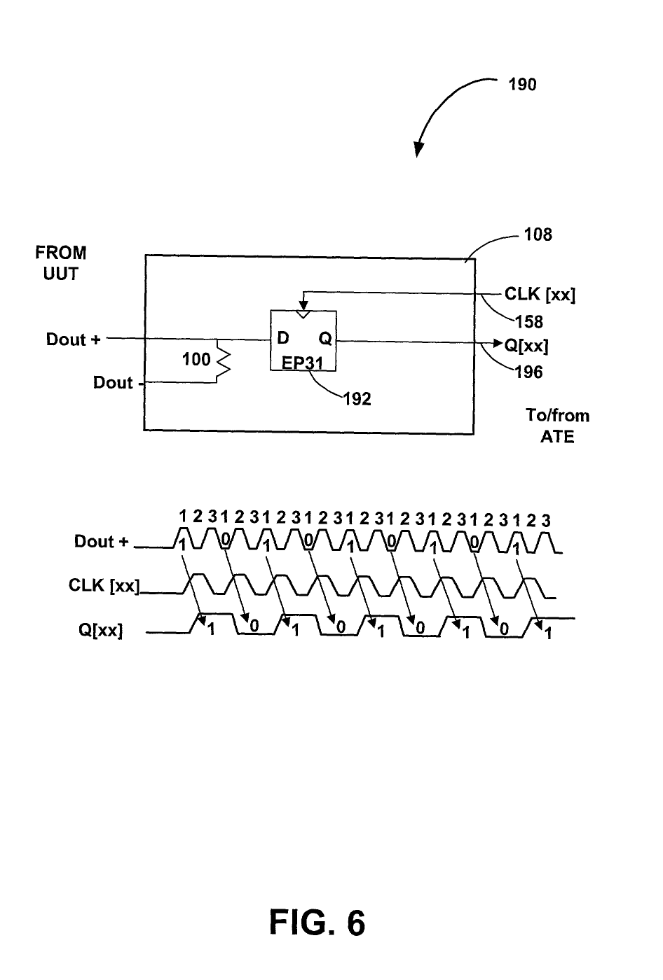

FIG. 6 is a schematic diagram 190 of an embodiment of a receiver module 108 of the system of FIG. 1, FIGS. 3A and 3B, and FIG. 4. The receiver module 108 samples the high-speed data results from the UUT 102. Sampling is performed to limit the bandwidth required of the ATE 104 pin electronics. Sampling data signals above 2 Gbps requires that the sampling logic reliably capture pulse widths of 500 ps or less. To meet the objective, a receiver module can encompass an array of ultra-high speed D-type flip-flop logic gates 192.

In order to capture all of the output bits from the UUT 102, the receiver module 108 uses separate passes (i.e. repetition of the sampling sequence). For instance, in the example involving three inputs, three separate passes are used to capture the output bits. During the second pass, the clock signal 158 from the ATE 104 is further delayed by ⅓ of the test period to capture the second bit of each group of three bits. Likewise, during the third pass, the clock is further delayed by another ⅓ test period to capture the third bit. The “Q” output 196 of the flip-flop 192 is transmitted back to the ATE 104. In one embodiment, a complete receiver (also referred to as a sampler) module 108 is constructed by replicating the logic 34 times. This provides for the capture of 34 independent UUT 102 output signals, each having a data rate of at least 2 Gbps.

Construction of the receiver module 108 typically involves using a six-layer printed circuit board. In one embodiment, the receiver module 108 contains 34 independent D-type flip-flop logic gates 192, arranged 17 on each side of the printed circuit board. Two 80-pin 50-Ohm connectors support over 50 differential high-speed data signals from the UUT 102, the 34 clocks 158 from the ATE 104, the 34 sampled data signals 160 to the ATE 104, and power/ground connections.

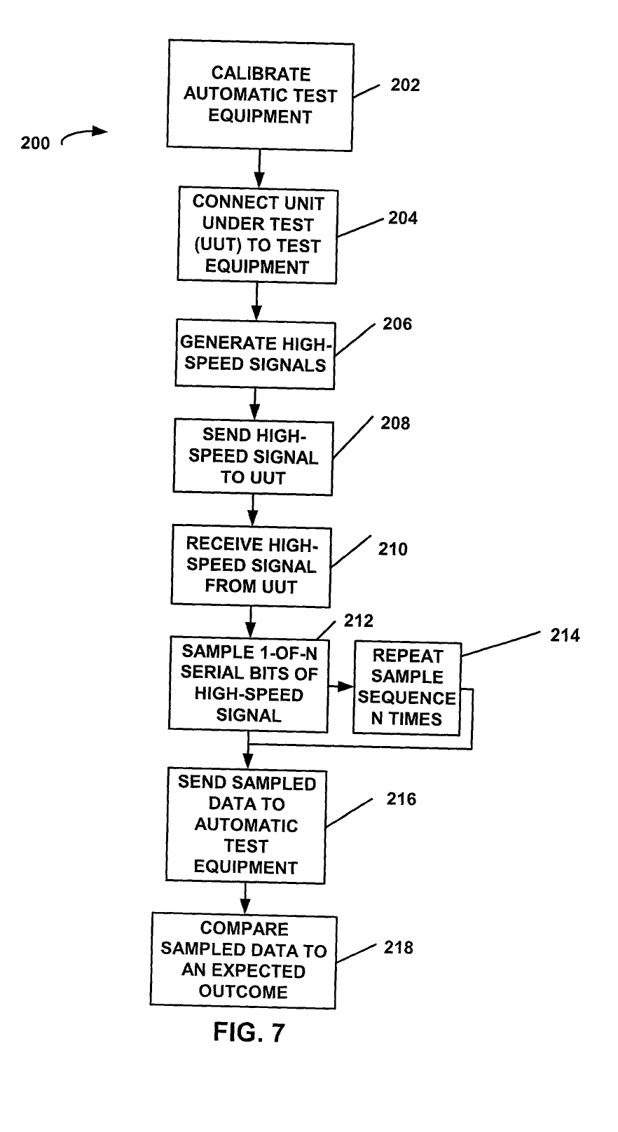

FIG. 7 is a flow chart 200 of the process for implementing the system 100 of FIG. 1. Any process descriptions or blocks in flow charts should be understood as representing modules, segments, or portions of code which include one or more executable instructions for implementing specific logical functions or steps in the process. Alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention. At 202, the ATE 104 is calibrated to maintain less than or equal to 25 ps timing accuracy at the UUT 102. At 204, the UUT 102 is connected to the ATE 104 as shown in FIGS. 3A and 3B. At 206, the driver module 106 generates high-speed signals. The high-speed signals are sent to the UUT 102 at 208. At 210, the receiver module 108 receives the high-speed signals from the UUT 102. At 212, the receiver module 108 samples 1-of-N bits of the high speed signal (where N=3 in the preceeding example). At 214, the sampling process is repeated until all N bits have been sampled. At 216, the sample data is send to the ATE 104. At 218, the sampled data is compared to the expected data results, for instance, using a comparator in the ATE 104.

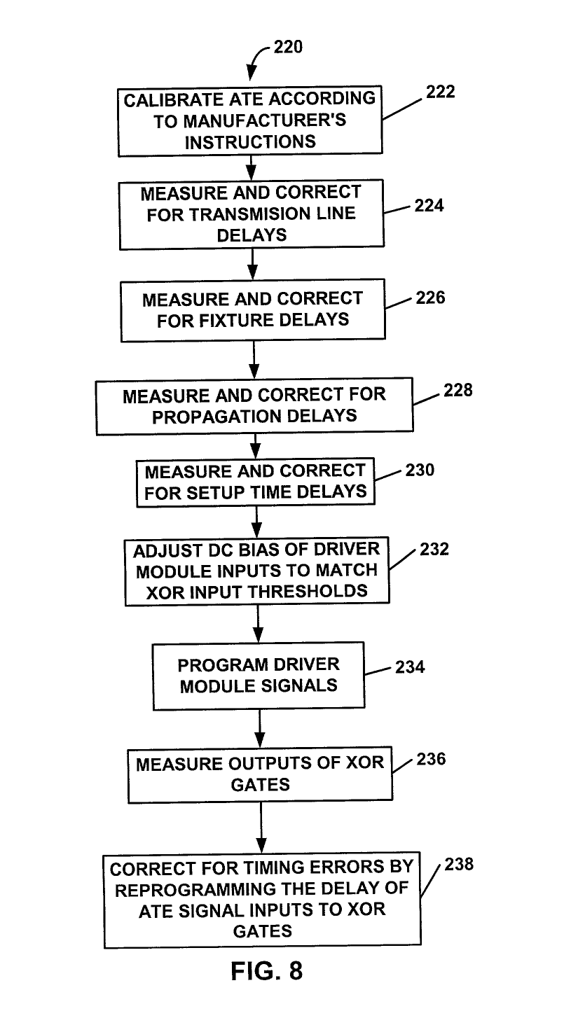

FIG. 8 is a flow chart 220 of the process for calibrating the system of FIG. 1, FIGS. 3A and 3B, and FIG. 4. Calibration is used to allow the system to maintain a timing accuracy less than or equal to 25 ps at the UUT 102. At 222, the ATE 104 is calibrated according to manufacturer's instruction. These calibrations typically include DC and AC calibrations that establish a nominal degree of accuracy in both voltage and timing, and establish the starting point for refining the calibration of the ATE 104. At 224, transmission line delays are measured and corrected for. Transmission line delays include delay that arises between the ATE pin electronics and the driver and receiver modules 106, 108. These delays can be measured using a time domain reflectometry (TDR) measurement. By correcting for these delays, signals are generally timed to within ±50 ps at the module 106, 108 inputs. Normally, TDR measurements are taken with the modules 106, 108 removed.

Another transmission delay is the delay in high speed paths between the modules 106, 108 and the UUT 102. These delays can be calculated using the known geometry of the interface PCB 122 and its material properties. Using well-known formulae, the delays are given as a function of the signal path lengths and the dielectric constant of the PCB insulator material. These delay values can be calculated to within about 5 ps.

At 226, fixture delays are measured and corrected. A high speed sampling oscilloscope can be used to measure the fixture delays to within about 10 ps. Corrections are normally included in the ATE programming to correct for the measured errors.

At 228, propagation delays through the XOR logic gates 166 are measured and corrected. A test fixture connecting the driver module 106 to test equipment that is optimized for measuring these delays is used to measure propagation delays. Along with using the high-speed sampling oscilloscope, these delays are measured to an accuracy of about 10 ps.

At 230, setup time delay is measured and corrected. A test fixture is used to connect the receiver module 108 to test equipment. The test fixture is optimized for measuring the setup time for each high-speed flip-flop logic gate 192. The setup time gives a measure of the effective delay between when the data arrives at the receiver module 108 pins and when the flip-flop clock transition must occur in order to capture the data bit. A high-speed sampling oscilloscope is used as a reference to ensure that the measurements are made to an accuracy of about 10 ps.

At 232, DC bias (e.g. voltage offset) of the driver module 106 inputs are adjusted to match the input threshold of the XOR gate 166. A known pulse-width signal is driven by the ATE 104 to one of the XOR gates 166. The pulse width of the gate output is measured, using for instance an oscilloscope. Ideally, the output pulse width matches the input pulse width. However, because of the finite rise and fall time of the ATE 104 signals, there may be an observed narrowing or widening of the output pulse if the ATE 104 signal is not exactly centered (e.g. in voltage) about the effective input threshold of the XOR gate 166. Changes to the ATE 104 signals voltage offset are made to correct for the measured pulse width distortion. The correction is within an accuracy of about 5 to 10 ps.

The above steps can establish accurate timing placement to within 50 ps or better. The driver module 106 signals are then programmed to produce the desired frequency when applied to the XOR gates 166. At 236, the outputs of the XOR gates 166 are monitored with the high-speed oscilloscope, or other means, to measure the logic transition edge placement to within 10 ps.

At 238, timing errors are corrected by reprogramming the delay of the ATE 104 signal inputs to be XOR gates 166. The combination of these steps serves to achieve an overall timing accuracy of about 25 ps or better. An optimal calibration procedure depends on the detailed construction of the interface PCB 122, and possibly the UUT 102 test requirements and/or test features.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. An automatic test system for testing a multiple gigahertz device, comprising:
a driver circuit coupled to the automatic test system and a multiple gigahertz device-under-test, the driver circuit for combining at least two signals provided by the automatic test equipment, and for generating an output signal having a speed greater than the speed of the at least two signals, the output signal provided to the multiple gigahertz device-under-test;
a receiver circuit coupled to the automatic test equipment and the multiple gigahertz device, the receiver circuit for sampling high speed output data from the multiple gigahertz device-under-test and for transmitting data to the automatic test equipment at a data rate supported by the automatic test system; and
a clock signal coupled to the receiver circuit for defining a sampling time of the receiver circuit.

2. The system of claim 1, wherein the clock signal provided to the receiver circuit advances incrementally upon each sampling of data to capture all high speed output data from the multiple gigahertz device-under-test.

3. The system of claim 1, further comprising a comparator coupled to the automatic test equipment for comparing the sampled high speed output data from the receiver circuit with an expected data sequence stored in the automatic test equipment.

4. The system of claim 1, wherein the driver circuit further comprises a high speed exclusive-OR logic gate to combine groups of three signals provided by the automatic test equipment.

5. The system of claim 4, further comprising a multilayer printed circuit board having termination resistors, decoupling capacitors and high performance connectors for connecting the multiple gigahertz device-under-test on a first side of the printed circuit board and the receiver circuit and the driver circuit on a second side of the printed circuit board.

6. The system of claim 4, further comprising resisters for alternating levels from the high speed exclusive or logic gate.

7. The system of claim 1, wherein the driver circuit comprises a configuration of eighteen, three-input high speed exclusive-OR logic gates.

8. The system of claim 1, wherein the output signal generated by the driver circuit comprises at least three GHz.

9. The system of claim 1, wherein the receiver circuit comprises a D-type flip-flop logic gate.

10. The system of claim 1, wherein the receiver circuit comprises 34 independent D-type flip-flop logic gates supporting 34 clock signals from the automatic test equipment and providing 34 sampled data signals to the automatic test equipment.

11. A driver device having one or more signal inputs by the driver device comprising:
logic configured to:
combine a plurality of input signals provided by a test device to produce a high speed output signal approximately equal to the sum of the plurality of input signals.

12. The driver device of claim 11, wherein the logic is implemented using a high speed exclusive-OR logic gate.

13. The driver device of claim 12, wherein the high speed exclusive-OR logic gate is mounted on a multilayer printed circuit board that couples on a first side to the test device.

14. The driver device of claim 11, wherein the high speed output signal comprises at least three GHz.

15. The driver device of claim 11, further comprising an interface to a receiver module having logic configured to sample a series of bits from a high speed signal output using a sample clock from the test device.

16. A receiver device comprising:
logic configured to sample 1-of-N serial bits of high speed data output from a unit under test in one sample sequence and to repeat the sample sequence N times.

17. The receiver device of claim 16, wherein the logic is performed using high speed D-type flip-flop logic gates.

18. The receiver device of claim 16, wherein the high speed data output further comprises at least three GHz.

19. The receiver device of claim 16, further comprising an interface to a driver module having logic configured to combine a plurality of input signals provided by a test device to produce a high speed output signal that couples into the unit under test.

20. A method for calibrating a system to maintain timing accuracy in a system having an automatic test equipment, a driver module, and a receiver module and that tests units requiring mega-gigahertz test signals comprising the steps of:
identifying sources of delays throughout the system;
measuring the delays from the identified sources of delay; and
adjusting settings on the automatic test equipment to correct the delays and to achieve an overall system delay of ±25 ps.

21. The method of claim 20, where the identifying sources of delays throughout the system further comprises:
identifying transmission line delays between pins of the automatic test equipment that connects driver modules and receiver modules;
identifying propagation delays through logic gates of driver modules;
identifying delays in setup delay time in flip-flop logic gates of the receiver module; and
identifying transmission line delay in signal paths between the driver module and the test unit and the receiver module and the test unit.

22. The method of claim 20, wherein the adjusting settings on the automatic test equipment further comprises adjusting inputs to the driver module coupled between the automatic test equipment and a unit under test to match the XOR input thresholds.

23. A method for testing digital circuits operating at multi-gigahertz speeds, comprising the steps of:
connecting a unit under test to test equipment;
generating a plurality of high speed signals to the unit under test using a driver module;
receiving the high speed signals from the unit under test by a receiver module that samples the high speed signals; and
sending sampled signals to the test equipment.

24. The method of claim 23, further comprising the step of comparing the sampled signals to an expected signal using the test equipment.
